(19) United States
(12) Patent Application Publication
(10) Pub. No.: US 2014/0247329 A1
(43) Pub. Date: Sep. 4, 2014

(54) IMAGE PROCESSING DEVICE, STEREOSCOPIC IMAGE DISPLAY APPARATUS, IMAGE PROCESSING METHOD AND IMAGE PROCESSING PROGRAM

(71) Applicant: KABUSHIKI KAISHA TOSHIBA, Tokyo (JP)

(72) Inventors: Norihiro NAKAMURA, Kawasaki-shi (JP); Takeshi Mita, Yokohama-Shi (JP); Kenichi Shimoyama, Tokyo (JP); Ryusuke Hirai, Tokyo (JP); Nao Mishima, Tokyo (JP)

(21) Appl. No.: 14/272,956

(22) Filed: May 8, 2014

Related U.S. Application Data
(63) Continuation of application No. PCT/JP2011/076447, filed on Nov. 16, 2011.

(51) Int. Cl. H04N 13/04

(52) U.S. Cl. CPC H04N 13/0468; H04N 13/0409
USPC 348/51

(57) ABSTRACT

According to an embodiment, there is provided an image processing device that displays a stereoscopic image on a display device having a panel and an optical aperture, including: a parallax image acquiring unit, a viewer position acquiring unit and an image generating unit. The parallax image acquiring unit acquires at least one parallax image, the parallax image being an image for one viewpoint. The viewer position acquiring unit acquires a position of a viewer. The image generating unit corrects a parameter for correspondence relationship between the panel and the optical aperture based on the position of the viewer relative to the display device, and generates an image, based on the corrected parameter, to which each pixel of the parallax image is allocated such that the stereoscopic image is visible to the viewer when the image is displayed on the display device.

### CROSS REFERENCE TO RELATED APPLICATIONS

This application is a Continuation of International Application No. PCT/W2011/076447, filed on Nov. 16, 2011, the entire contents of which is hereby incorporated by reference.

### FIELD

An embodiment of the present invention relates to an image processing device, a stereoscopic image display apparatus, an image processing method and an image processing program.

### BACKGROUND

A stereoscopic image display apparatus enables a viewer to observe stereoscopic images by naked eyes without using special glasses. Such a stereoscopic image display apparatus displays a plurality of images that differ in viewpoint (hereinafter, each of the images is referred to as a parallax image), and controls light rays from these parallax images with, for example, a parallax barrier and a lenticular lens. At this time, the images to be displayed must be rearranged such that intended images can be observed in their respective intended directions when the viewer looks at the displayed images through the parallax barrier, the lenticular lens or the like. Hereinafter, this rearranging method is referred to as a pixel mapping. Thus, the light rays that are controlled by the parallax barrier, the lenticular lens or the like, and the pixel mapping adapted therefor, are led to both eyes of the viewer, Then, the viewer can recognize a stereoscopic image, if the observing position of the viewer is appropriate. Such a zone where the viewer can observe the stereoscopic image is called a viewing zone.

However, there is a problem that such a viewing zone is restrictive. There is a pseudoscopic viewing zone, which is an observing zone where, for example, a viewpoint for an image perceived by the left eye is positioned relatively to the right side compared to a viewpoint for an image perceived by the right eye, and the stereoscopic image cannot be correctly recognized.

Conventionally, as a technique for setting the viewing zone depending on the position of the viewer, a technique is known in which the position of the viewer is detected by some means (for example, a sensor), and parallax images prior to the pixel mapping are swapped depending on the position of the viewer so that the viewing zone is controlled.

However, in the swapping of the parallax images by the conventional art, the position of the viewing zone can only be discretely controlled, and cannot be sufficiently adapted for the position of the viewer who continuously moves. Therefore, the picture quality of the images varies depending on the position of the viewpoint. Furthermore, during the movement, specifically, at the time when the parallax images are swapped, or the like, the viewer finds the moving images to be suddenly switched and feels uncomfortable. This is because the positions where the parallax images can be viewed is each previously fixed by a design of the parallax barrier or lenticular lens and its positional relationship to sub-pixels of a panel and, and it is impossible to deal with deviating from the positions no matter how the parallax images are swapped.

### BRIEF DESCRIPTION OF THE DRAWINGS

FIG. 1 is a diagram showing a configurational example of a stereoscopic image display apparatus including an image processing device according to an embodiment;

FIGS. 2A and 2B are views showing an optical aperture and a display element;

FIG. 3 is a diagram showing a processing flow of the image processing device shown in FIG. 1;

FIGS. 4A to 4C are views for explaining an angle between a panel and a lens, a pixel mapping and meanings of various terms;

FIGS. 5A to 5C are views for explaining a relation between a parameter for correspondence relationship between the panel and the optical aperture, and a viewing zone; and

FIG. 6 is a view showing an “X”, “Y”, “Z” coordinate space in which the origin is set to the center of the panel.

### DETAILED DESCRIPTION

According to an embodiment, there is provided an image processing device that displays a stereoscopic image on a display device having a panel and an optical aperture, including: a parallax image acquiring unit, a viewer position acquiring unit and an image generating unit.

The parallax image acquiring unit acquires at least one parallax image, the parallax image being an image for one viewpoint.

The viewer position acquiring unit acquires a position of a viewer.

The image generating unit corrects a parameter for correspondence relationship between the panel and the optical aperture based on the position of the viewer relative to the display device, and generates an image, based on the corrected parameter, to which each pixel of the parallax image is allocated such that the stereoscopic image is visible to the viewer when the image is displayed on the display device.

An image processing device according to the present embodiment can be used in stereoscopic image display apparatuses that enable a viewer to observe stereoscopic images by naked eyes, such as TVs, PCs, smartphones and digital photo frames. The stereoscopic image is an image including a plurality of parallax images that mutually have parallaxes. The viewer observes this image through an optical aperture such as a lenticular lens and a parallax barrier, and thereby can visually recognize the stereoscopic image. Here, the image described in the embodiment may be either a still image or a moving image.

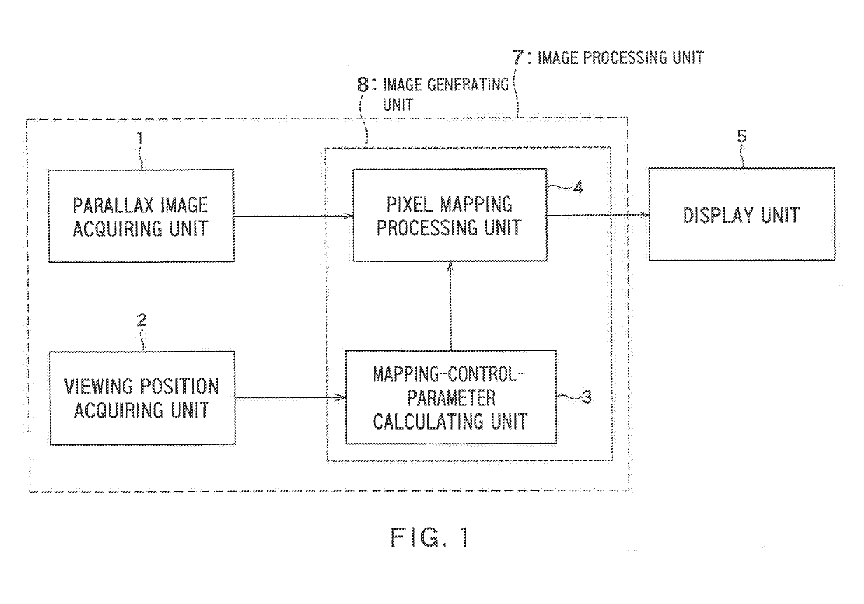

FIG. 1 is a block diagram showing a configurational example of a stereoscopic image display apparatus according to the present embodiment. The stereoscopic image display apparatus includes an image acquiring unit 1, a viewing position acquiring unit 2, a mapping-control-parameter calculating unit 3, a pixel mapping processing unit 4 and a display unit (display device) 5. The image acquiring unit 1, the viewing position acquiring unit 2, the mapping-control-parameter calculating unit 3 and the pixel mapping processing unit 4 constitute the image processing device 7. The mapping-control-parameter calculating unit 3 and the pixel mapping processing unit 4 constitute an image generating unit 8.

The display unit 5 is a display device for displaying the stereoscopic image. The range (zone) where the viewer can observe the stereoscopic image displayed by the display device is referred to as a viewing zone.

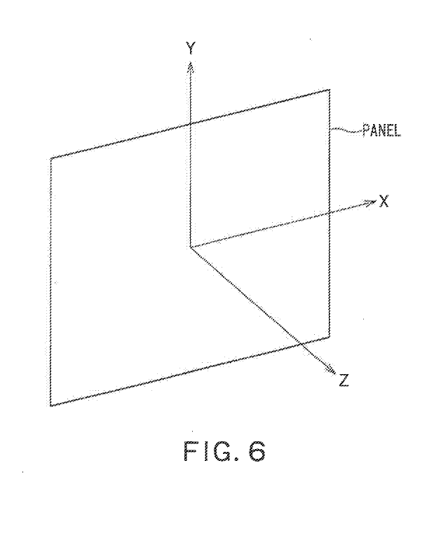

In the present embodiment, as shown in FIG. 6, the origin is set to the center of the display surface (display) of the panel, and the “X”, “Y”, and “Z” axes are set to the horizontal, perpendicular and normal directions of the display surface, respectively, in real space. In the present embodiment, a height direction refers to the “Y” axis direction. However, the coordinate setting method in real space is not limited to this.

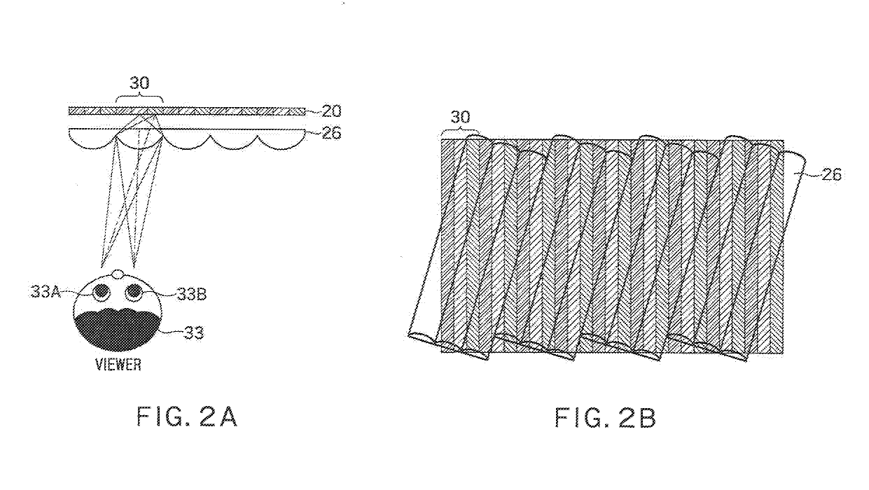

As shown in FIG. 2A, the display device includes a display element 20 and an aperture controlling unit 26. The viewer visually recognizes the stereoscopic image displayed on the display device by observing the display element 20 through the aperture controlling unit 26.

The display element 20 displays the parallax image used for displaying the stereoscopic image. Examples of the display element 20 include a two-dimensional direct-view display such as an organic electro luminescence (organic EL), a liquid crystal display (LCD) and a plasma display panel (PDP), and a projection display.

The display element 20 may have a known configuration. For example, sub-pixels for each color of RGB are arranged in a matrix, in which RGB constitute one pixel, respectively (in FIG. 2A, each of the small rectangles as the display element 20 indicates an RGB sub-pixel). In this case, the sub-pixels of the respective RGB colors which are arrayed in a first direction constitute one pixel, respectively, and the adjacent pixels which are arrayed by the number of the parallaxes in a second direction perpendicular to the first direction constitute a pixel group. An image displayed on the pixel group is referred to as an element image 30. The first direction is, for example, the column direction (the vertical direction or the “Y” axis direction), and the second direction is, for example, the row direction (the horizontal direction or the “X” axis direction). As for the arrangement of the sub-pixels of the display element 20, it is allowable to employ other known arrangements. Also, the sub-pixels are not limited to three colors of RGB. For example, four colors may be employed.

The aperture controlling unit 26 makes light rays that are radiated forward from the display element 20 to be emitted in a predetermined direction through an aperture (hereinafter, the aperture having such a function is referred to as an optical aperture). Examples of the optical aperture 26 include a lenticular lens and a parallax barrier.

The optical apertures are arranged so as to correspond to each of the element images 30 of the display element 20. One of the optical apertures corresponds to one of the element images. In displaying of a plurality of the element images 30 on the display element 20, the display element 20 displays a parallax image group (multi-parallax image), which corresponds to a plurality of the directions of the parallaxes. Light rays from this multi-parallax image pass through the respective optical apertures. Then, the viewer 33 positioned in the viewing zone observes pixels included in the element images 30 through the left eye 33A and the right eye 33B. Thus, the images that differ in parallax are each displayed toward the left eye 33A and the right eye 33B of the viewer 33, and thereby the viewer 33 can observe the stereoscopic image.

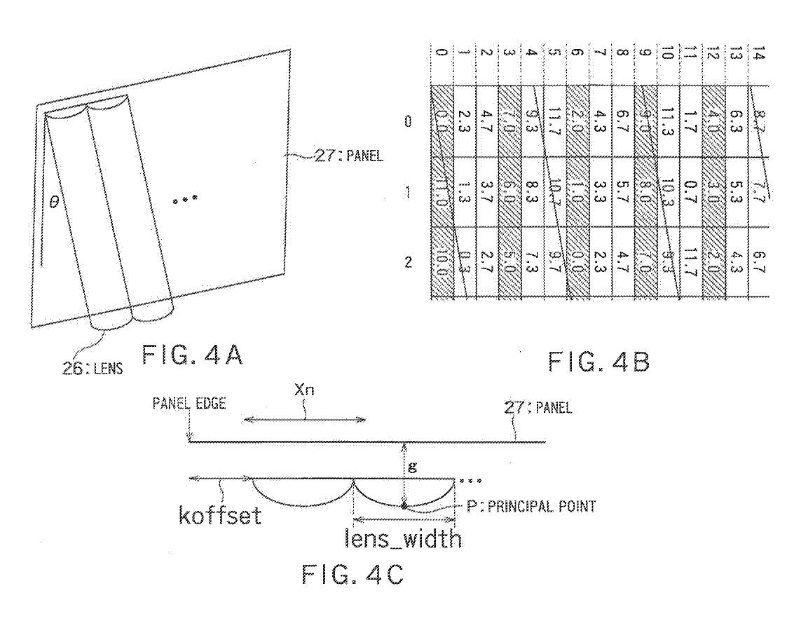

In the present embodiment, as shown in the plan view of FIG. 2B and the perspective view of FIG. 4A, the optical aperture 26 is disposed parallel to the display surface of the panel, and there is a predetermined slope “θ” between the drawing direction of the optical aperture and the first direction (the “Y” axis direction) of the display element 20.

Each block of the stereoscopic image display apparatus shown in FIG. 1 will be described in detail below.

### Image Acquiring Unit 1

The image acquiring unit 1 acquires one or more parallax images depending on the number of the parallax images (the number of parallaxes) intended to be displayed. The parallax image is acquired from a storage medium. For example, the parallax image may be acquired from a hard disk, a server or the like in which the parallax image is previously stored. Alternatively, the image acquiring unit 1 may be configured to directly acquire the parallax image from an input device such as a camera, a camera array in which a plurality of cameras are connected to each other, and a stereo camera.

### Viewing Position Acquiring Unit 2

The viewing position acquiring unit 2 acquires a real-space position of the viewer in a viewing zone as a three-dimensional coordinate value. The position of the viewer can be acquired, for example, by using an image taking device such as a visible light camera and an infrared camera, or other devices such as a radar and a sensor. From the information obtained by these devices (in the case of the cameras, a taken image), the position of the viewer is acquired using a known technique.

For example, in the case of using the visible light camera, by an image analysis of an image obtained by image taking, the viewer is detected and the position of the viewer is calculated. Thereby, the viewing position acquiring unit 2 acquires the position of the viewer.

In the case of using the radar, by performing signal processing on an obtained radar signal, the viewer is detected and the position of the viewer is calculated. Thereby, the viewing position acquiring unit 2 acquires the position of the viewer.

In detecting the viewer in the human detection and position calculation, any target that allows for judgment of whether to be a human or not may be detected, such as a face, a head, a complete human body and a marker. The position of the eyes of the viewer may be detected. Here, the method of acquiring the position of the viewer is not limited to the above-described method.

### Pixel Mapping Processing Unit 4

The pixel mapping processing unit 4 rearranges (allocates) each sub-pixel of the parallax image group acquired by the image acquiring unit 1, based on control parameters such as the number of parallaxes “N”, the slope “9” of the optical aperture relative to the “Y” axis, an amount of deviation “koffset” in the “X” axis direction between the optical aperture and the panel (shift amount in terms of panel), and a width “Xn” of a portion of the panel that corresponds to one optical aperture. Thereby, the pixel mapping processing unit 4 determines each element image 30. Hereinafter, a plurality of the element images 30 displayed on the whole of the display element 20 are referred to as an element image array. The element image array is an image to which each pixel of the parallax image is allocated such that the stereoscopic image is visible to the viewer when being displayed.

In the rearrangement, firstly, a direction in which light rays radiated from each sub-pixel of the element image array emit through the optical aperture 26 is calculated. For this calculation, for example, a method described in “Image Preparation for 3D-LCD” can be used.

For example, the emitting direction of the light rays can be calculated using the following Formula 1. In the formula, the “sub_x” and the “sub_y” each represent a coordinate value of the sub-pixel when the top left corner of the panel is set as a reference. The “v (sub_x, suviewing positionb_y)” represents a direction in which the light rays radiated from the sub-pixel at the “sub_x”, “sub_y” emit through the optical aperture 26.

$$v ( sub\_x , sub\_y ) = \frac{( sub\_x + koffset - 3 \times sub\_y / atan θ ) mod Xn}{Xn} \times N \qquad ( Formula 1 )$$

The direction of the light rays determined by this formula is represented by a number showing a direction in which light radiated from each sub-pixel emits through the optical aperture 26. Here, a zone that is taken along the drawing direction of the optical aperture 26 and has a horizontal width “Xn” in the “X” axis direction as a reference is defined, an emitting direction of light radiated from a position corresponding to the boundary of the zone that is the most negative boundary for the X axis is defined as 0, an emitting direction of light radiated from a position of “Xn/N” from the boundary is defined as 1, and similarly, other emitting directions are defined in order. For further detailed explanation, please see “Image Preparation for 3D-LCD”.

Thereafter, the direction calculated for each sub-pixel is associated with the acquired parallax image. For example, it is possible to select, from the parallax image group, a parallax image whose viewpoint position at the generation of the parallax image is the closest to the direction of the light rays, and to generate a parallax image at an intermediate viewpoint position by interpolation with other parallax images. Thereby, the parallax image acquiring a color (reference parallax image) is determined for each sub-pixel.

FIG. 4B shows an example of the reference parallax image numbers, where the number of parallaxes “N”=12, and the numbers 0 to 11 are allocated to the parallax images respectively. The numbers “0, 1, 2, 3, . . . ” arrayed in the cross direction on the plane of paper show the sub-pixel positions in the “X” axis direction, and the numbers “0, 1, 2, . . . ” arrayed in the longitudinal direction show the sub-pixel positions in the “Y” axis direction. The lines in the diagonal direction on the plane of paper show the optical apertures that are disposed at the angle “0” relative to the “V” axis. The numeral described in each rectangular cell corresponds to the reference parallax image number and the emitting direction of light described above. When the numeral is an integer, the integer corresponds to a reference parallax image with the identical number. A decimal corresponds to an image interpolated by reference parallax images with two numbers including the decimal therebetween. For example, if the numeral is 7.0, the parallax image with the number 7 is used as the reference parallax image, and if the numeral is 6.7, an image interpolated by the reference parallax images with the numbers 6 and 7 is used as the reference parallax image. Finally, the reference parallax images are applied to the whole of the display element 20 such that each sub-pixel is allocated to the sub-pixel at the corresponding position in the element image array. Thus, the value allocated to each sub-pixel of each display pixel in the display device is determined. Here, if the parallax image acquiring unit 1 reads only a single parallax image, the other parallax images may be generated from the single parallax image. For example, if only the above-described single parallax image corresponding to the number 0 is read, the parallax images corresponding to the numbers 1 to 11 may be generated from the parallax image.

The method in “Image Preparation for 3D-LCD” need not necessarily be used for the pixel mapping processing. It is allowable to use any method as long as it is the pixel mapping processing, based on a parameter for correspondence relationship between the panel and the optical aperture, in the above example, the parameter that defines the positional deviation between the panel and the optical aperture, and the parameter that defines the width of the portion of the panel corresponding to one optical aperture.

Originally, each parameter is determined by the relationship between the panel 27 and the optical aperture 26, and does not vary unless the hardware is redesigned. In the present embodiment, the viewing zone is moved to a desired position by compensating the above-described parameters (in particular, the amount of deviation “koffset” in the “X” axis direction between the optical aperture and the panel, and the width “Xn” of the portion of the panel corresponding to one optical aperture) based on the viewpoint position of the observer. For example, in the case of using the method in “Image Preparation for 3D-LCD” for the pixel mapping, the viewing zone can be moved by compensating the parameters in accordance with the following Formula 2.

koffset=koffset+r_offset

Xn=r_Xn (Formula 2)

The “r_offset” represents a compensation amount for the “koffset”. The “r_Xn” represents a compensation amount for the “Xn”. The method of calculating these compensation amounts will be described later.

In the above Formula 2, the “koffset” is defined as an amount of deviation of the panel relative to the optical aperture. When the “koffset” is defined as an amount of deviation of the optical aperture relative to the panel, the following Formula 3 is used. As for the compensation of the “Xn”, this formula is the same as Formula 2.

koffset=koffset−r_offset

Xn=r_Xn (Formula 3)

### Mapping-control-parameter Calculating Unit 3

The mapping-control-parameter calculating unit 3 calculates a compensation parameter (compensation amount) for moving the viewing zone according to the observer. The compensation parameter is also called a mapping-control-parameter. In the present embodiment, the parameters intended to be corrected are two parameters of the “koffset” and “Xn”.

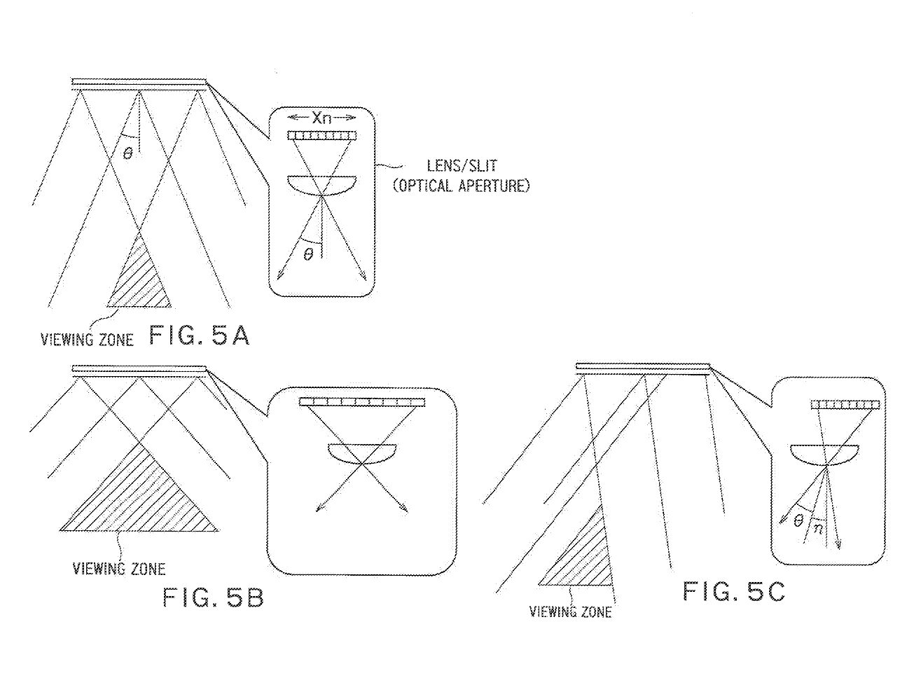

When the panel and the optical aperture are in the state shown in FIG. 5A, if the positional relationship between the panel and the optical aperture is deviated in a horizontal direction, as shown in FIG. 5C, the viewing zone is moved in the deviated direction. In the example of FIG. 5C, since the optical aperture is shifted to the left on the plane of paper, the light rays are biased to the left at the angle “η” compared to the case in FIG. 5A, and thereby the viewing zone is also biased to the left. This is equivalent to a movement of the displayed image in the opposite direction, when considered that the position of the lens is fixed at the original position. In the pixel mapping, such a deviation is originally given as the “koffset”, and the “v (sub_x, sub_y)” is determined in view of the deviation between the two. Thereby, even if the two are relatively deviated from each other, the viewing zone is made in front of the panel. In the present embodiment, an improvement is added to this. That is, the deviation “koffset” between the panel and the optical aperture is corrected depending on the position of the viewer so as to be increased or decreased compared to the amount of the physical deviation. Thereby, it is possible to continuously (finely) correct the horizontal (“X” axis direction) position of the viewing zone by the pixel mapping, and to continuously change the horizontal (“X” axis directional) position of the viewing zone, which in the conventional art can only be discretely changed by swapping parallax images. Accordingly, when the viewer is at any horizontal position (the position in the “X” axis direction), it is possible to adequately adapt the viewing zone for the viewer.

Also, When the panel and the optical aperture are in the state shown in FIG. 5A, expanding the width “Xn” of the portion of the panel corresponding to one optical aperture, as shown in FIG. 5B, makes the viewing zone closer to the panel (that is, the width of the element image in FIG. 5B is wider than that in FIG. 5A). Therefore, by compensating the value of the “Xn” such that the value increases or decreases compared to the actual value, it is possible to continuously (finely) correct the vertical (“Z” axis directional) position of the viewing zone by the pixel mapping. Thereby, it is possible to continuously change the vertical (“Z” axis directional) position of the viewing zone, which in the conventional art can only be discretely changed by swapping parallax images. Accordingly, when the viewer is at any vertical position (the position in the “Z” axis direction), it is possible to adequately adapt the viewing zone.

Thus, by adequately compensating the parameters “koffset” and “Xn”, it is possible to continuously change the position of the viewing zone either in the horizontal direction or in the vertical direction. Accordingly, even when the observer is at any position, it is possible to set the viewing zone adapted for the position.

Here are methods of calculating the compensation amount “r_koffset” for the “koffset” and the compensation amount “r_Xn” for the “Xn”.

### r_koffset

The “r_koffset” is calculated from the “X”-coordinate value of the viewing position. Concretely, the “r_koffset” is calculated by the following Formula 4, using the “X”-coordinate value of a current viewing position, a viewing distance “L” that is a distance from the viewing position to the panel (or lens), and a gap “g” that is a distance between the optical aperture (in the case of a lens, the principal point “P”) and the panel (refer to FIG. 4C). The current viewing position is acquired by the viewing position acquiring unit 2, and the viewing distance “L” is calculated from the current viewing position.

$$r\_koffset = \frac{X \times g}{L} \qquad ( Formula 4 )$$

The “r_Xn” is calculated from the “Z”-coordinate value of the viewing position by the following Formula 5. The “lens_width” (refer to FIG. 4C) is a width taken along the “X” axis direction (the longitudinal direction of the lens) of the optical aperture.

$$r\_Xn = \frac{Z + g}{Z} \times lens\_width \qquad ( Formula 5 )$$

### Display Unit 5

The display unit 5 is a display device including the above-described display element 20 and optical aperture 26. The viewer observes stereoscopic images displayed on the display device by observing the display element 20 through the optical aperture 26.

As described above, examples of the display element 20 include a two-dimensional direct-view display such as an organic electro luminescence (organic EL), a liquid crystal display (LCD) and a plasma display panel (PDP), and a projection display. The display element 20 may have a known configuration. For example, sub-pixels for each color of RGB are arranged in a matrix, in which each pixel is composed of a set of RGB sub-pixels. As for the arrangement of the sub-pixels of the display element 20, it is allowable to employ other known arrangements. Also, the sub-pixels are not limited to three colors of RGB. For example, four colors may be employed.

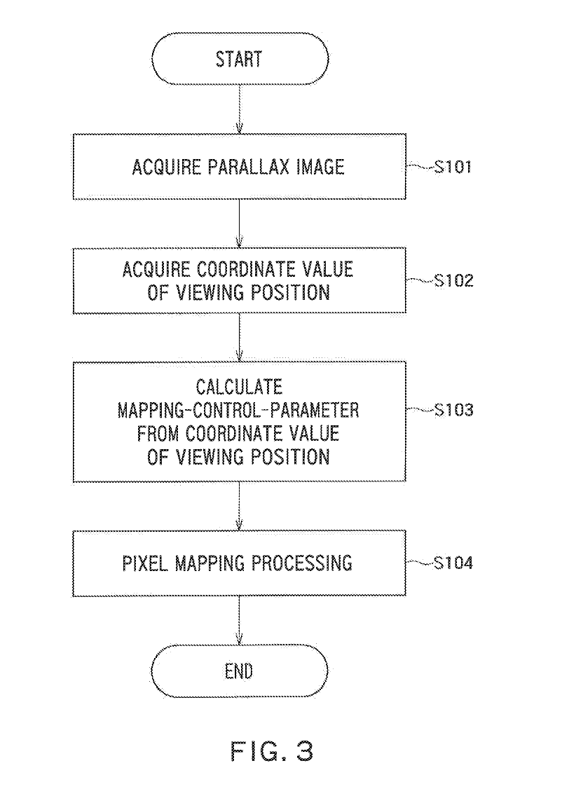

FIG. 3 is a flowchart showing an operation flow of the image processing device shown in FIG. 1.

In step S101, the parallax image acquiring unit acquires one or more parallax images from the storage medium.

In step S102, the viewing position acquiring unit 2 acquires the position information of the viewer using an image taking device or a device such as a radar and a sensor.

In step S103, the mapping-control-parameter calculating unit 3 calculates the compensation amounts (mapping-control-parameters) for compensating the parameters for correspondence relationship between the panel and the optical aperture based on the position information of the viewer. Examples of calculating the compensation amounts are as described in Formulas 4 and 5.

In step S104, based on the compensation amounts, the pixel mapping processing unit 4 corrects the parameters for correspondence relationship between the panel and the optical aperture (refer to Formulas 2 and 3). Based on the corrected parameters, the pixel mapping processing unit 4 generates the image to which each pixel of the parallax image is allocated such that the stereoscopic image is visible to the viewer when being displayed on the display device (refer to Formula 1).

Thereafter, the display unit 5 drives each display pixel to display the generated image on the panel. The viewer can observe the stereoscopic image by observing the display element of the panel through the optical aperture 26.

As described above, in the present embodiment, the viewing zone is controlled in the direction of the viewer at the pixel mapping by compensating the physical parameter, which is uniquely determined originally, depending on the position of the observer. As the physical parameter, the positional deviation between the panel and the optical aperture and the width of the portion of the panel corresponding to one optical aperture are used. Since these parameters can have any value, it is possible to more exactly adapt the viewing zone for the viewer compared to the conventional art (discrete control by swapping parallax images). This allows the viewing zone to exactly follow in response to a movement of the viewer.

So far, the embodiments of the present invention have been described. Each embodiment described above is presented as an example, and is not intended to limit the scope of the invention. These novel embodiments can be implemented in other various modes, and various omissions, replacements or modifications can be made without departing from the spirit of the invention.

The above-described image processing device according to the embodiment has a hardware configuration including a central processing unit (CPU), a ROM, a RAM and a communication I/F device. The CPU loads a program stored in the ROM into the RAM and executes it, and thereby the functions of the above-described each unit is achieved. Alternatively, not limited to this, at least a part of the functions of each unit can be achieved in an individual circuit (hardware).

The program executed by the above-described image processing device according to the embodiment may be stored in a computer connected to a network such as the Internet and be provided by download via the network. Also, the program executed by the above-described image processing device according to each embodiment and modification may be provided or distributed via the network such as the Internet. In addition, the program executed by the above-described image processing device according to the embodiment may be previously embedded in a ROM or the like to be provided.

1. An image processing device that displays a stereoscopic image on a display device having a panel and an optical aperture, comprising:
a parallax image acquiring unit configured to acquire at least one parallax image, the parallax image being an image for one viewpoint;
a viewer position acquiring unit configured to acquire a position of a viewer; and
an image generating unit configured to correct a parameter for correspondence relationship between the panel and the optical aperture based on the position of the viewer relative to the display device, and to generate an image, based on the corrected parameter, to which each pixel of the parallax image is allocated such that the stereoscopic image is visible to the viewer when the image is displayed on the display device.

2. The image processing device according to claim 1,
wherein the image generating unit corrects the parameter depending on a position of the viewer relative to the panel in a horizontal direction and a viewing distance of the viewer.

3. The image processing device according to claim 2,
further comprising a mapping-control-parameter calculating unit,
wherein the parameter is an amount of positional deviation between the panel and the optical aperture,
the mapping-control-parameter calculating unit configured to calculate a compensation amount depending on the position of the viewer relative to the panel in the horizontal direction and the viewing distance of the viewer, and
the image generating unit corrects the parameter based on the compensation amount.

4. The image processing device according to claim 1,
wherein the image generating unit corrects the parameter depending on a position of the viewer relative to the panel in a vertical direction and a width of the optical aperture.

5. The image processing device according to claim 4,
further comprising a mapping-control-parameter calculating unit,
wherein the parameter indicates a width of a portion of the panel, the portion of the panel corresponding to one optical aperture,
the mapping-control-parameter calculating unit configured to calculate a compensation amount depending on the position of the viewer relative to the panel in the vertical direction and the width of the optical aperture, and
the image generating unit corrects the parameter based on the compensation amount.

6. The image processing device according to claim 1,
wherein the viewer position acquiring unit recognizes a face by means of analyzing an image taken by an image taking device, and acquires the position of the viewer based on the recognized face in the image.

7. The image processing device according to claim 1,
wherein the viewer position acquiring unit acquires the position of the viewer by means of processing a signal detected by a sensor that detects a movement of the viewer.

8. An image processing method for displaying a stereoscopic image on a display device having a panel and an optical aperture, comprising:
acquiring at least one parallax image, the parallax image being an image for one viewpoint;
acquiring a position of a viewer; and
correcting a parameter for correspondence relationship between the panel and the optical aperture based on the position of the viewer relative to the display device, and generating an image, based on the corrected parameter, to which each pixel of the parallax image is allocated such that the stereoscopic image is visible to the viewer when the image is displayed on the display device.

9. A non-transitory computer readable medium having instructions stored therein which cause a computer to execute, for displaying a stereoscopic image on a display device having a panel and an optical aperture, processing of steps comprising:
acquiring at least one parallax image, the parallax image being an image for one viewpoint;
acquiring a position of a viewer; and
correcting a parameter for correspondence relationship between the panel and the optical aperture based on the position of the viewer relative to the display device, and generating an image, based on the corrected parameter, to which each pixel of the parallax image is allocated such that the stereoscopic image is visible to the viewer when the image is displayed on the display device.

10. An stereoscopic image display device, comprising:
a display unit having a panel and an optical aperture, comprising:
a parallax image acquiring unit configured to acquire at least one parallax image, the parallax image being an image for one viewpoint;
a viewer position acquiring unit configured to acquire a position of a viewer; and
an image generating unit configured to correct a parameter for correspondence relationship between the panel and the optical aperture based on the position of the viewer relative to the display unit, and to generate an image, based on the corrected parameter, to which each pixel of the parallax image is allocated such that the stereoscopic image is visible to the viewer when the image is displayed on the display unit,
wherein the display unit displays the image generated by the image generating unit.
